(19) United States
(12) Patent Application Publication
(10) Pub. No.: US 2024/0133478 A1
(43) Pub. Date: Apr. 25, 2024

(54) WEAR PLATE FOR MEDIA FLOW CONTROL VALVE IN SHOT PEENING

(71) Applicant: Electronics Inc., Mishawaka, IN (US)

(72) Inventors: Benjamin Wilson, Mishawaka, IN (US); Bryan Chevrie, South Bend, IN (US); Jack Champaigne, Mishawaka, IN (US)

(21) Appl. No.: 18/493,235

(22) Filed: Oct. 23, 2023

Related U.S. Application Data
(60) Provisional application No. 63/418,797, filed on Oct. 24, 2022.

(51) Int. Cl. F16K 25/04; B24C 7/00

(52) U.S. Cl. CPC F16K 25/04; B24C 7/00

(57) ABSTRACT

A sacrificial media shield to be used in flow control valves in high volume wheel blast peening machines, comprised from a wear resistant material. This shield is intended to prevent undesired wear to the valve and its components via an offset arrangement, which isolates the majority of contact with the abrasive media stream to the media shield. This prevents plastic contamination within the media stream. Being a replaceable component, the shield extends the operating life of the valve by avoiding replacement of the valve in its entirety.

### CROSS-REFERENCE TO RELATED APPLICATION

This application is a non-provisional conversion of U.S. Pat. App. No. 63/418,797 entitled “WEAR PLATE FOR MEDIA FLOW CONTROL VALVE IN SHOT PEENING” filed Oct. 24, 2022, the contents of which are incorporated in their entirety and for all purposes.

### TECHNICAL FIELD

This disclosure generally relates to shot peening, and, specifically, providing a sacrificial wear plate in a flow control valve for shot peening to protect the valve.

### BACKGROUND

Shot peening is a surface enhancement process that imparts a compressive residual stress into the surface of a metal component by impacting metallic, ceramic, or glass peening particles at high velocity.

### BRIEF DESCRIPTION OF THE DRAWINGS

FIG. 1 is a perspective view of an example wear plate for use with an example shot peening valve.

FIG. 2 a perspective view of the example shot peening valve with the example wear plate of FIG. 1.

FIG. 3 is a cross-sectional view of example valve of FIG. 2 taken along line 3-3 and including an enlarged view of media flowing through the example valve in operation.

### DETAILED DESCRIPTION

Shot peening is a surface enhancement process that imparts a compressive residual stress into the surface of a metal component by impacting metallic, ceramic, or glass peening media at high velocity. Popular methods for propelling these peening media include air blast systems and wheel blast wheels. In the air blast systems, shot peening media, sometimes referred to a simply “media” is introduced by various methods into the path of high pressure air and accelerated through a nozzle directed at the surface to be peened. In wheel blast style peening applications, shot peening media is fed to the blades of a rotating wheel and propelled toward an impingement target. This media travels through the peening arrangement in very high volumes, in the range of 100-2000 pounds per minute.

To regulate the flow rate of media, a flow control device is used. These flow control devices, or valves, comprise an arrangement of conductive pole pieces, a center bar, electric coils, spacers, and permanent magnet(s). In the off-state, the magnetic field produced by the permanent magnet(s) and pole pieces provides a force within the “working gap” which is significant to prevent the flow of media between the pole pieces and center bar. This force is referred to as “holding strength.” In the on-state, the electric coils are charged to a predefined amperage, inducing a counteractive magnetic field to reduce the holding strength of the pole-piece arrangement, permitting a metered rate of media flow. This high rate of flow prevents undesirable wear to the valve body, as well as the magnetic components, as media travels through the working gap. This wear negatively impacts the performance of the valve, and further reduces the operating life of the valve. To counteract this wear, a user is typically required to repair or replace the valve in its entirety.

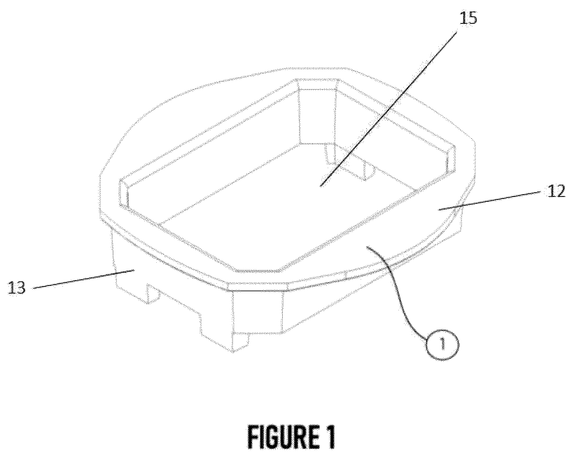

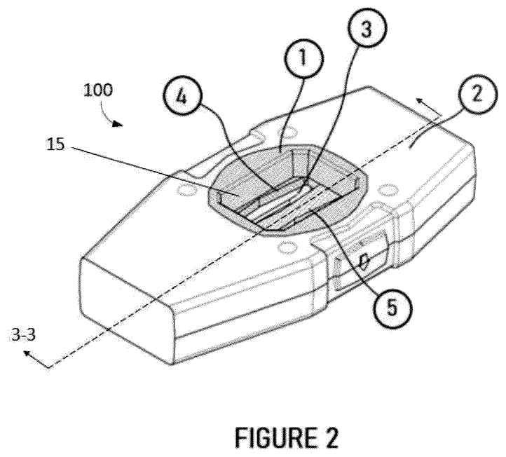

Referring now to the drawings, wherein like numerals refer to the same or similar features in the various views, FIG. 1 is a top perspective view of an example wear plate 1 (or shield) configured to protect portions of an example shot peening valve 100 of FIG. 2. As shown in FIG. 1, the wear plate 1 may include an outer lip 12, lower protrusions 13, and define an opening 15 through which shot peening media may flow. The outer lip 12 may cover a portion of a valve body 2, described below. In particular, the outer lip 12 may guide positioning of the wear plate 1 within the valve body 2, as the extension of the outer lip 12 prevents the wear plate 1 from being inserted too far into the valve body 2. The lower protrusions 13 may extend perpendicularly away from the outer lip 12 such that the lower protrusions 13 extend in the direction of media 6 flow. In some examples, the lower protrusions 13 secure the wear plate 1 to the valve body by a friction fit with internal components of the valve body 2 (e.g., pole pieces 4, center bar 5, etc.).

As shown in FIG. 2, the valve 100 includes a valve body 2, a defined working gap 3, a plurality of pole pieces 4, and a center bar 5. While one of the pole pieces 4 is illustrated in FIG. 2, due to the orientation of the figure, it will be appreciated that additional pole pieces are hidden from view. As shown in FIG. 2, the pole pieces 4 are mounted around the periphery of the working gap 3. As shown in FIG. 2, the center bar 5 is mounted within the working gap 3, generally bisecting the working gap 3 into two working gaps. In this example, each working gap 3 is defined as a portion of the valve body 2 opening between the pole pieces 4 and the center bar 5. In those examples in which the center bar 5 is omitted, the working gap 3 is defined as the portion of the valve body 2 opening between the pair of pole pieces 4. The wear plate 1 is positioned directly above (relative to the orientation of FIG. 2) the pole pieces 4 and the center bar 5. In this example, the wear plate 1 is positioned on the inlet side of working gap 3, the inlet side being defined as side in which media 6 enters the working gap 3 of valve 100. The wear plate 1 is a sacrificial component intended to prolong the operating life of the valve 100 when used in any peening process, including air-blast or wheel-blast peening operations.

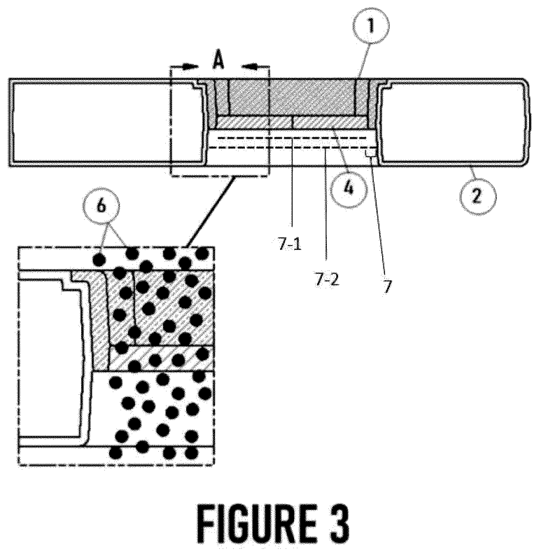

In this example, the media wear plate 1 is made from any semi-rigid material that is softer (e.g., of a lower hardness, more malleable, more susceptible to surface stress, etc.) than the valve body 2. For example, the media wear plate 1 may be made of plastic (e.g., nylon, ABS, PETG, PVC, etc.), metal (such that it is softer than the valve body 2), rubber (e.g., silicone, nitrile, natural rubber, etc.), or composites (e.g., glass-filled nylon, plastic blends, etc.). This softer material resists degradation due to contact with the media 6 (shown in FIG. 3) while still maintaining the structural rigidity of the valve body 2. By isolating abrasive wear to the wear plate 1, the operating life of the valve 100 is prolonged. The wear plate 1 can be replaced indefinitely, rather than replacing the valve body 2 and all enclosed components.

The wear plate 1 is attached to valve 100 and sits within the working gap 3, above the pole pieces 4 and the center bar 5. The wear plate 1 may be attached by friction fit. For example, the lower protrusions 13 may secure the wear plate 1 to the valve body by a friction fit with internal components of the valve body 2 (e.g., pole pieces 4, center bar 5, etc.).

As the media 6 travels from above the valve 100 and through the working gap 3, the media 6 passes over the surface of the wear plate 1. As shown in FIG. 3, the wear plate 1 has an amount of offset 7 from the valve body 2 which guides the media 6 away from the surface of the valve body 2. As shown in FIG. 3, the offset 7 is defined by the amount of material of the lower protrusions 13 positioned between the valve body 2 and pole pieces 4. In some examples, the offset 7 is calculated by taking the difference between the width of the valve 100 (shown along line 7-1) and the width of the working gap 3 (shown along line 7-2). As shown in FIG. 3, the width of the working gap 3 is less than the width of the valve 100. This ensures the abrasive media 6 does not come into contact with the valve body 2 and reduces the impact of the media 6 on the valve body 2, thereby preventing unnecessary wear. Additionally, the wear plate 1 partially covers the pole pieces 4 and the center bar 5, preventing wear to the magnetic components. As shown, the pole pieces 4 and the center bar 5 each extend into or across the opening within the valve body 2. Because a size of the opening 15 of the wear plate 1 is less than a size of the valve body 2 opening, a portion of the wear plate 1 (e.g., the outer lip 12) extends over some amount of the pole pieces 4 and the center bar 3.

While this disclosure has described certain examples, it will be understood that the claims are not intended to be limited to these examples except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What is claimed:

1. A system for reducing wear to a shot peening valve, comprising:
a valve comprising a valve body and defining a working gap through which a shot peening media may flow, the valve configured to control a flow rate of the shot peening media; and
a wear plate comprising a semi-rigid material, the wear plate mountable to the valve body proximate the working gap to cover a portion of the valve body and configured to isolate abrasive wear from the shot peening media away from the valve.

2. The system of claim 1, wherein the semi-rigid material is plastic.

3. The system of claim 1, wherein the semi-rigid material has a lower hardness than a material of the valve body.

4. The system of claim 1, the valve further comprising:
a pole piece mounted around a periphery of the working gap; and
a center bar mounted within the working gap, generally bisecting the working gap into two working gaps.

5. The system of claim 4, wherein the wear plate is mounted to the valve body on an inlet side of the valve.

6. The system of claim 4, wherein the wear plate is configured to cover at least a portion of the pole piece and the center bar.

7. The system of claim 4, wherein a width of the valve is a first length, and the width of the working gap is a second length, the second length being less than the first length.

8. A method for reducing wear to a shot peening valve comprising:
providing a valve comprising a valve body defining an opening through which a shot peening media may flow, the valve body configured to control a flow rate of the shot peening media; and
providing a wear plate comprising a semirigid material, the wear plate mountable to the valve body proximate the opening to cover a portion of the valve body.

9. The method of claim 8, wherein the semirigid material has a lower hardness factor than a material of the valve body.

10. The method of claim 8, the valve further comprising:
a pole piece mounted around a periphery of the opening; and
a center bar mounted within the opening, generally bisecting the opening into two working gaps.

11. The method of claim 10, wherein the wear plate is mounted to the valve body on an inlet side of the valve.

12. The method of claim 10, wherein the wear plate is configured to cover a at least a portion of the pole piece and the center bar.

13. The method of claim 8, wherein a width of the valve is a first length, and a width of the opening is a second length, the second length being less than the first length.
